(19) United States
(12) Patent Application Publication
(10) Pub. No.: US 2011/0093790 A1
(43) Pub. Date: Apr. 21, 2011

(54) PREEMPTIVE CACHING FOR WEB-BASED SYSTEMS

(75) Inventor: Jed Maczuba, Windham, NH (US)

(73) Assignee: International Business Machines Corporation, Armonk, NY (US)

(21) Appl. No.: 12/582,851

(22) Filed: Oct. 21, 2009

(51) Int. Cl. G06F 3/01; G06F 21/00; G06F 15/173

(52) U.S. Cl. 715/745; 715/760; 726/3; 709/226

(57) ABSTRACT

The present invention provides a system and methods for pre-fetching of customized web content associated with a user profile in a cache upon receiving user identification, but before the user provides authentication details. Further, the present invention provides a method and system for rendering of the cached customized web content to the user once the user authentication is received. The method and system decrease the time required for a user to request and receive a dynamically generated user-tailored web page post-authentication. It controls the cache pre-fetch mechanism through a trigger. The trigger notifies the cache (web server) to pre-fetch user-specific resources into a user profile graph either when a user cookie is present when the user navigates to the web site or as user authentication credentials are entered to the web page by the user. The present invention permits the pre-fetching of user information prior to actual authentication by the web application.

### FIELD OF THE INVENTION

The present invention provides for systems and methods for preemptive caching for improving web page performance for recognized users. The present invention also provides for business applications for allowing preemptive caching for improving web page performance for recognized users.

### BACKGROUND OF THE INVENTION

It imperative during Internet usage for users accessing web content that the access be as fast as possible, which includes access of web content that has been customized for a user. Caching in servers and in client software has been used in the past for this purpose with some success.

The World Wide Web (the web) is one of the most popular information delivery channels. The rate of the web's growth has been and continues to be exponential. Driven by the tremendous growth, the web as an information delivery platform has also evolved exponentially. Web sites are not merely systems of interlinked hypertext documents accessed via the Internet for delivering static content. They are dynamic, robust, fully functional applications capable of displaying complex quantitative information and providing rich user interactivity. They are essential productivity tools, distribution channels and collaboration means. They have become necessary components of the lives of users and impact the way users' lives are conducted.

The changing nature of the web, however, has also created significant challenges to the underlying technology platforms that enable it. Specifically, these pressures have resulted in significant response-time performance challenges to emerging web applications. Web engineers have developed hardware and software solutions in an effort to delivery better response time to users. For example, faster processors, increased memory capacity and specialized proxy servers all demonstrate hardware solutions to address the performance issues.

On the software side, caching has emerged as a well known and proven technique for improving the performance of web sites. Caching is the process of obtaining and storing in “fast memory” relevant resources such web pages, images and other electronic information and data. One of the fundamental design challenges in constructing a cache mechanism is determining the optimum approach to populate the cache. Ideally, cache is loaded in advance of the required use (pre-fetch). By pre-fetching information and resources prior to their need, the application can quickly serve them when requested.

A number of systems have been established that leverage pre-fetching mechanisms for improved web site performance. Some of these utilize techniques of predictive or probabilistic methods system. However, these systems are inefficient in terms of bandwidth consumed and accurately predicting the resources that the user will actually request. If the criteria for determining which resources the user will request is not accurate, not only will unnecessary computing resources be consumed retrieving and storing information that will never be asked for, but also, the user will not receive the performance benefits from the pre-fetch mechanism.

In addition, prior art systems inadequately deal with web applications that generate dynamic web pages—that is, web pages that are constructed upon request from the user. Static web applications deliver web pages that are already established and stored either locally or remotely in advance of the user request. In static web page web sites, resources are delivered to all users that visit the particular Universal Resource Locator (URL). Because of this, the ability to cache the page and resources for future access is relatively straightforward and a number of mechanisms are effective.

A dynamically constructed page, however, may be unique for each visitor or perhaps even each visit. Many current day applications leverage complex underlying data information sources such as relational database management systems, content management systems, business intelligence engines and existing legacy systems. Some web sites employ sophisticated personalization where each user receives content that is tailored to him/her based on a potentially complex set of parameters such as previous buying habits or Internet browsing behavior. Some banking applications display financial information such as account summaries, account balances, transaction history and bill payment details. Not only is this information specific to each user, but also changes frequently in response to variable conditions. In these systems, there is limited opportunity to cache static pages and resources for improved page performance. One must focus on the underlying data required to satisfy the user request. This underlying data represented as an “object graph” is used to manage the core data and the data dependencies. The graph may contain varying user data ranging from account information to targeted marketing material to user profile characteristics.

Previous systems have addressed the use of a generic object cache. Subsequent systems have utilized methods to ensure consistency between the cache and the potentially volatile source information. These systems, however, fail to address the critical challenge of adequately priming the cache and thereby guaranteeing optimal performance for a user.

### SUMMARY OF THE INVENTION

The present invention provides a system and method for pre-fetching customized web content associated with a user profile in a cache upon receiving user identification, but before the user provides authentication details.

Further, the present invention provides a method and system for rendering cached customized web content to the user once the user authentication is received.

The present invention provides system having a pre-fetching cache that permits the benefits of fast access to data without the drawbacks of other pre-fetch mechanisms. An approach that provides the intended benefits of a pre-fetched cache tuned for dynamic web applications is disclosed.

The present invention discloses a method and system for improved caching of customized web content. More specifically, it provides a method and system for pre-fetching customized web content associated with a user profile in a pre-fetching cache upon receiving the user identification and before the user provides user authentication details. Once the user authentication details are received by the pre-fetching cache, the pre-fetched customized web content is rendered to the user.

The present invention is a method and system for decreasing the time required for a user to request and receive a dynamically generated user-tailored web page post-authentication. The present invention controls the cache pre-fetch mechanism through a trigger. The trigger notifies the cache to pre-fetch user-specific resources into a user profile graph either when a user cookie is present as the user navigates to the web site or as user authentication credentials are entered to the web page by the user. The present invention permits the pre-fetching of user information prior to actual authentication by the web application.

It may further comprise a method in a system having a web server having a cache, and a user having a web browser, the method for pre-fetching, to the cache, customized web content for the user having a user profile, the user profile having a unique user identifier identifying the user, the method comprising receiving in the web server the unique user identifier from the user, associating customized web content with the user profile based upon the user identifier of the user, pre-fetching the associated customized web content to the cache based upon the unique user identifier and the user profile, and then receiving, in the web server, user authentication authenticating the user to the web server.

It may further comprise a system for pre-fetching, to a cache, customized web content for a user having a user profile, the user profile having a unique user identifier identifying the user, the system comprising a cache, a receiver for receiving the unique user identifier from the user and for receiving in a web server a user authentication, an associating unit for associating customized web content with the user profile based upon the unique user identifier, and a pre-fetching unit for pre-fetching the associated customized web content to the cache.

It may further comprise a computer program product embodied in a computer readable medium for operating in a system comprising a processing unit, a memory, a bus, input/output (I/O) interfaces, a web server having a cache, and a user having a web browser, for implementing a method for pre-fetching, to the cache, customized web content for the user having a user profile, the user profile having a unique user identifier identifying the user, the method comprising receiving in the web server the unique user identifier from the user, associating customized web content with the user profile based upon the unique user identifier of the user, pre-fetching the associated customized web content to the cache based upon the unique user identifier and the user profile and then receiving in the web server user a user authentication authenticating the user to the web server.

It may further comprise a method for deploying computing infrastructure comprising integrating computer-readable code into a computing system, the computing system having a web server having a cache, and a user having a web browser, wherein the code in combination with the computing system is capable of performing a process for pre-fetching, to the cache, customized web content for the user having a user profile, the user profile having a unique user identifier identifying the user, the process comprising receiving, at the web server, a hypertext transfer protocol (HTTP) request having a Universal Resource Locator (URL) identifying a web page from the web browser, constructing by the web server the identified web page, rendering the constructed identified web page to the user, receiving at the web browser from the user a username, determining, by the web server, whether a user cookie exists, if a user cookie exists, reading the user cookie and extracting a unique user identifier by the web server, pre-fetching customized user web content based upon the unique user identifier and populating a user profile cache including a user profile graph associated with the user, receiving a password from the user, and processing by the web server a dynamic web page using the customized user web content and the cached user profile graph.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a data processing system suitable for implementing an embodiment of the present invention.

FIG. 2 shows a network for implementing an embodiment of the present invention.

FIG. 3 shows an illustrative web page displayed on a monitor.

FIG. 4 shows an illustrative web page displayed on a monitor of the present invention.

FIG. 5 illustrates an embodiment of the method of the present invention.

FIG. 6 illustrates a system for implementing the method of the present invention.

FIG. 7 illustrates another embodiment of the system of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention.

### DETAILED DESCRIPTION OF THE INVENTION

The present invention comprises a system and method for preemptive caching for improving web page performance for recognized users.

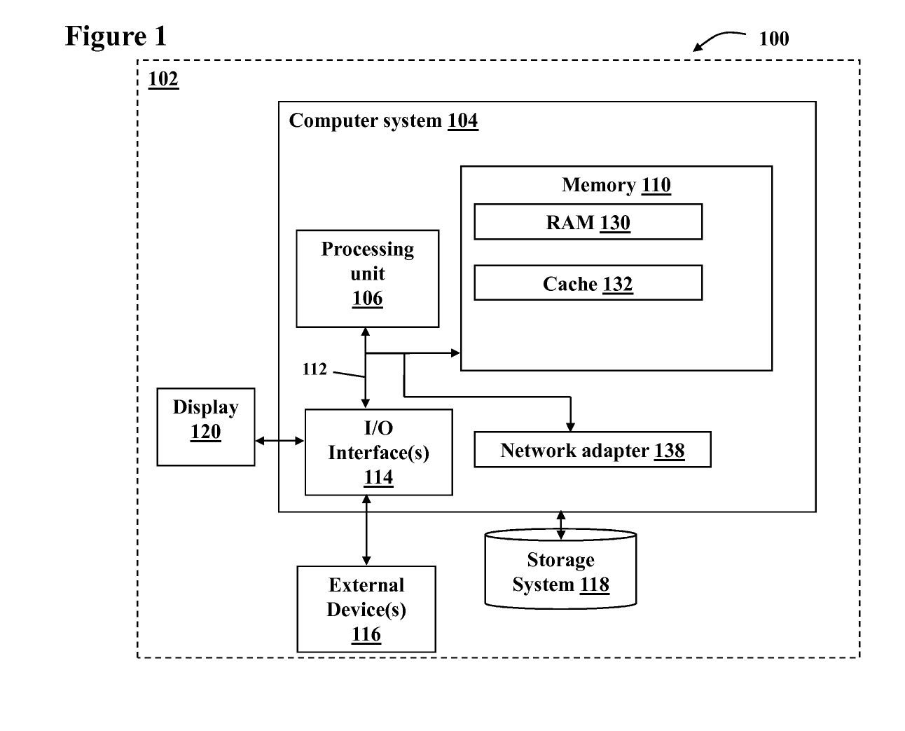

FIG. 1 shows a system 100 that may have a data processing system 102 suitable for implementing an embodiment of the present invention. Data processing system 102 may have a computer system 104 connected to a display 120, external device(s) 116 and video camera 140 or other peripheral devices for providing a user an interface to computer system 140 being connected via I/O interface(s) 114. Computer system 104 may have an internal bus 112 for providing internal communication between such modules as processing unit 106, I/O interface(s) 114, network adapter 138 and memory 110. Memory 110 may have random access memory (RAM) 130, cache 132 and storage system 118 or other forms of memory. RAM may take the form of integrated circuits that allow stored data to be accessed in any order (i.e., at random). Storage system 118 may take the form of tapes, magnetic discs and optical discs and are generally used for long term storage of data. Cache 132 is a memory for storing a collection of data—duplicating original values stored elsewhere or computed earlier, where the original data is expensive to fetch (owing to longer access time) or to compute, compared to the cost of reading the cache. In other words, a cache is a temporary storage area where frequently accessed data can be stored for rapid access. Once the data is stored in the cache, it can be used in the future by accessing the cached copy rather than re-fetching or recomputing the original data. A cache has proven to be extremely effective in many areas of computing because access patterns in typical computer applications have locality of reference.

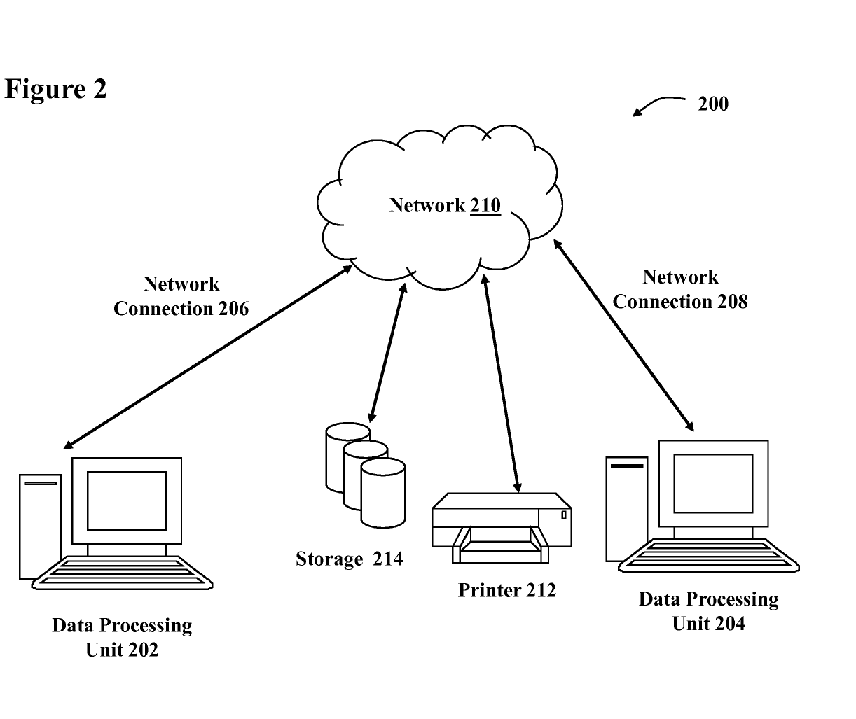

FIG. 2 shows a network system 200 for implementing an embodiment of the present invention. Network system 200 may have a network 210 or group of interconnected computers, such as data processing units 202, 204, via network connections 206, 208 and may be of the type, e.g., a local area network (LAN) or internetwork. Printer 212 and storage 214 may be connected to network 210 via network connections 216, 218. Basic network components may include network interface cards, repeaters, hubs, bridges, switches and routers. Data processing units 202, 204 may be computers such as web servers or personal computers, or other user agents. A web server generally has hardware and software that are responsible for accepting HTTP requests from clients (user agents such as web browsers), and serving them HTTP responses along with optional data contents, which usually are web pages such as HTML documents and linked objects (images, etc.). In this document, the term “web browser” is used but any application for retrieving, presenting, and traversing information resources on the Internet must be considered.

Hypertext Transfer Protocol (HTTP) is an application-level protocol for distributed, collaborative, hypermedia information systems. Its use for retrieving inter-linked resources led to the establishment of the World Wide Web. HTML, which stands for HyperText Markup Language, is the predominant markup language for web pages.

A web site generally is a collection of related web pages, images, videos or other digital assets that are addressed with a common domain name or IP address in an Internet Protocol-based network. A web site is hosted on at least one web server, accessible via the Internet or a private local area network.

A webpage generally is a document, typically written in plain text interspersed with formatting instructions of HTML, XHTML. A webpage may incorporate elements from other websites with suitable markup anchors.

A website may be of many different types such as community sites, new sites, or other types of sites and have various types of web pages such as static web pages or dynamic web pages. Classical hypertext navigation, with HTML or XHTML alone, provides “static” content, meaning that the user requests a web page and simply views the page and the information on that page.

However, web navigation can also provide an “interactive experience” that is termed “dynamic”. Content (text, images, form fields, etc.) on a web page can change, in response to different contexts or conditions. There are two ways to create this kind of interactivity:

1. Using client-side scripting to change interface behaviors within a specific web page, in response to mouse or keyboard actions or at specified timing events. In this case the dynamic behavior occurs within the presentation; and/or

2. Using server-side scripting to change the supplied page source between pages, adjusting the sequence or reload of the web pages or web content supplied to the browser. Server responses may be determined by such conditions as data in a posted HTML form, parameters in the URL, the type of browser being used, the passage of time, or a database or server state.

The result of either technique is described as a dynamic web page, and both may be used simultaneously.

Due to the pressures of significant response-time performance challenges to emerging web applications, hardware and software solutions have been developed in an effort to delivery better response time to users. For example, faster processors, increased memory capacity and specialized proxy servers all demonstrate hardware solutions to address the performance issues.

On the software side, caching has emerged as a well known and proven technique for improving the performance of web sites. Caching is the process of obtaining and storing in “fast memory” relevant resources such web pages, images and other electronic information and data. One of the fundamental design challenges in constructing a cache mechanism is determining the optimum approach to populate the cache. Ideally, cache is loaded in advance of the required use (pre-fetch). By pre-fetching information and resources prior to their need, the application can quickly serve them when requested.

Some systems have been established that leverage pre-fetching mechanisms for improved web site performance. Some of these utilize techniques of predicative or probabilistic methods system. However, these systems are inefficient in terms of bandwidth consumed and accurately predicting the resources that the user will actually request. If the criteria for determining which resources the user will request is not accurate, not only will unnecessary computing resources be consumed retrieving and storing information that will never asked for, but also, the user will not receive the performance benefits from the pre-fetch mechanism.

In addition, prior art systems inadequately deal with web applications that generate dynamic web pages—that is, web pages that are constructed upon request from the user. Static web applications deliver web pages that are already established and stored either locally or remotely in advance of the user request. In static web page web sites, resources are delivered to all users that visit the particular Universal Resource Locator (URL). Because of this, the ability to cache the page and resources for future access is relatively straightforward and a number of mechanisms are effective.

A dynamically constructed page, however, is unique for each visitor or perhaps even each visit. Many current day applications leverage complex underlying data information sources such as relational database management systems, content management systems, business intelligence engines and existing legacy systems. Some web sites employ sophisticated personalization where each user receives content that is tailored to him/her based on a potentially complex set of parameters such as previous buying habits or Internet browsing behavior. Some banking applications display financial information such as account summaries, account balances, transaction history and bill payment details. Not only is this information specific to each user, but also changes frequently in response to variable conditions. In these systems, there is limited opportunity to cache static pages and resources for improved page performance. One must focus on the underlying data required to satisfy the user request. This underlying data represented as an “object graph” is used to manage the core data and the data dependencies. The graph may contain varying user data ranging from account information to targeted marketing material to user profile characteristics.

Previous systems have addressed the use of a generic object cache. Subsequent systems have utilized methods to ensure consistency between the cache and the potentially volatile source information. These systems, however, fail to address the critical challenge of adequately priming the cache and thereby guaranteeing optimal performance for a user.

The present invention has several advantages over other systems. While other systems attempt to improve response time of static web pages, the present invention is ideal for either static or dynamic web sites. In addition, the present invention avoids the limitations with pure predictive approaches. The present invention is not predictive but preemptive in nature. That is, the present invention focuses on leveraging specific knowledge of the user's identity to load discrete user data in advance of the actual usage. The present invention utilizes an approach to loading user-specific information prior to the actual authentication by the user. The present invention can populate the user-specific cache without interrupting the user. Many practical implementations of dynamic web applications today fetch data and load the cache only after the user has authenticated to the application.

The present invention both ensures the user-specific information is pre-fetched in advance of the user's needs and avoids the consequences of pre-fetching potentially unused information as other systems face. The present invention is also advantageous because it provides improved response time to the most commonly accessed information on a web site—the immediate page after the user authenticates to the application. With the present invention, once authentication occurs, the application will already have the necessary information persisted in fast-cache for construction of the web page.

This ready access to information results in more responsive web applications.

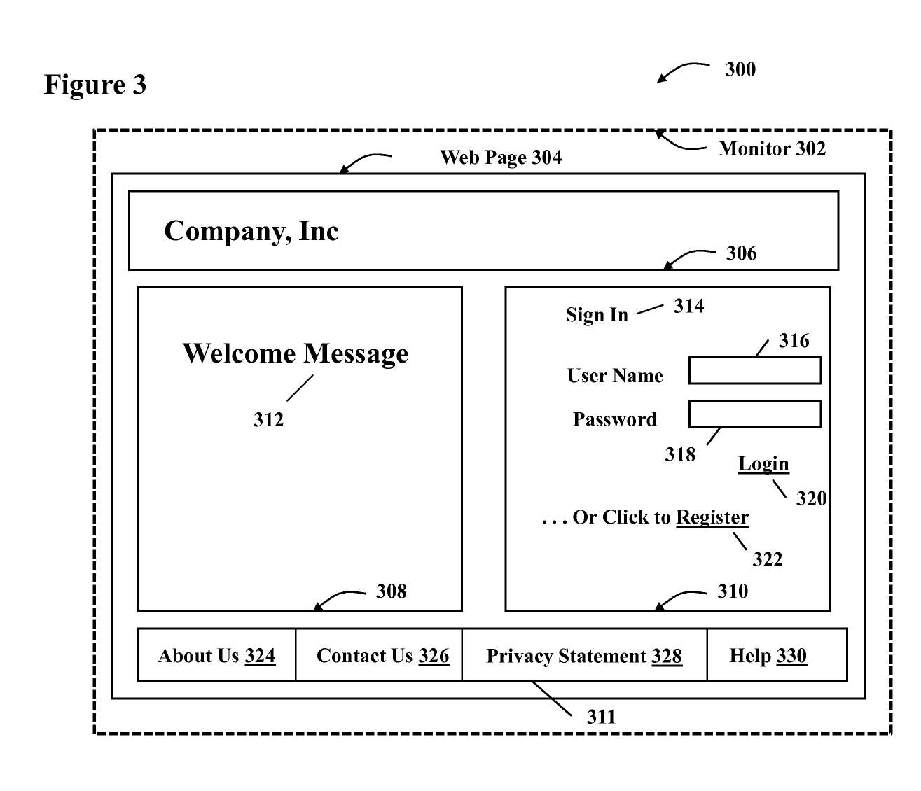

FIG. 3 highlights common components of a static web page that typically is used as the homepage for an organization. FIG. 3 shows a system 300 having a monitor 302 for displaying a web page 304. “Monitor” is used but any display device having the ability to display web content can be used such as in a handheld device or other portable display device. In this figure, all users receive the same web page 304 when the homepage URL is entered regardless of whether the user is an authenticated or an anonymous user of the application. In this example, no user-tailored content or functionality is displayed while there is the ability for the user to enter an authenticated state of the application in the authentication portion 310 of the web page 304 on monitor 302. To authenticate, a previously registered user would type in his user name at 316 and password at 318 and click the “Login” button 320. If the user has not previously registered at the web site, the user may click on the “Register” button 322 that would navigate the user to a registration portion of the web site. The web page 304 further has the typical generic global navigation section 311 having “About Us” 324, “Contact Us” 326, “Privacy Statement” 328 and “Help” 330 portions used to view other non-protected content on the web site. Company logo text (“Company, Inc.” shown in Company logo frame 306) and/or image resources such as in Welcome Message frame 312 are initially generic for all users.

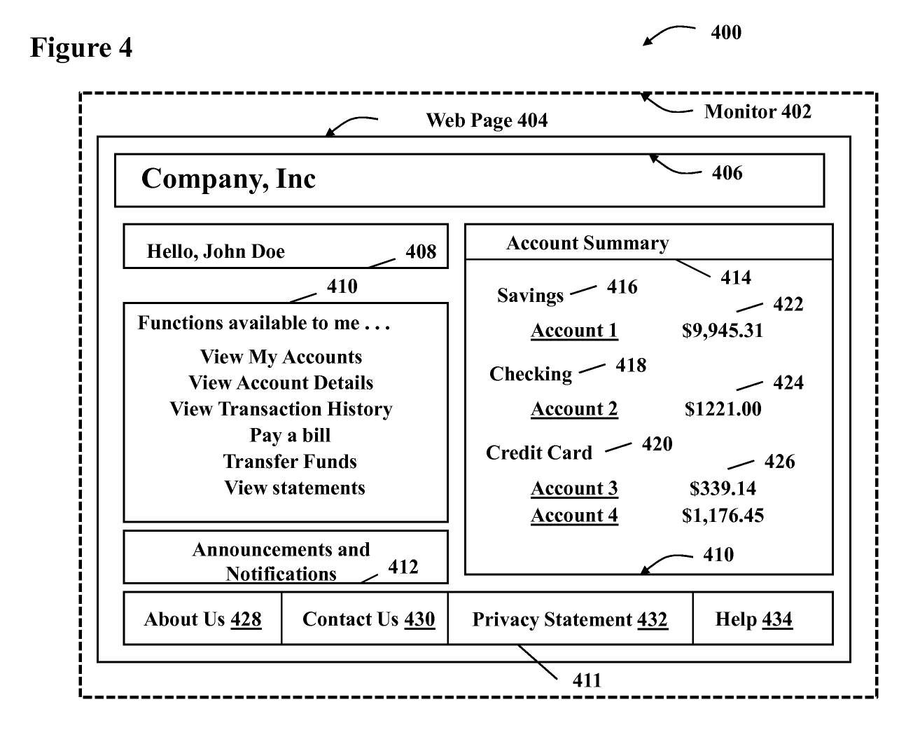

FIG. 4 illustrates a dynamic web page structure 400 having a monitor 402 for displaying web page 404. While the company logo portion 406 shown as “Company, Inc.” may be generic to all users, web page 404 contains a mixture of information (such as “Hello, John Doe” greeting 408) and resources (such as “Functions available to me . . . ” 410, “Announcements and Notifications” 412, “Account summary” 414, etc.) tailored specifically to the user that has entered authentication credential on a prior web page and generic information/resources that is not user specific. User-specific greetings 408 demonstrating web page personalization are tailored to the user that is authenticated. Available functions and navigation options shown demonstrate capabilities to the authorized user. These are tailored to the authenticated user based on various product or user specific conditions. Financial data may display accounts (410) and account balances (414) for the authenticated user. Announcements and notifications 412 may contain potentially mixed generic and user-specific information. For example, announcements of scheduled system outages may be displayed for all users (generic). An example of an announcement may be of account alerts/warnings or for groups of users as in the example of all users with saving accounts (user-specific). The present invention allows for customization that permits the user to decide whether this section of information should be displayed or what generic and/or user-specific information is displayed when the page is rendered.

Generic global navigation sections 411 (i.e., “About Us” 428, “Contact Us” 430, “Privacy Statement” 432, and “Help” 434) may be used to view other non-protected content on the web site.

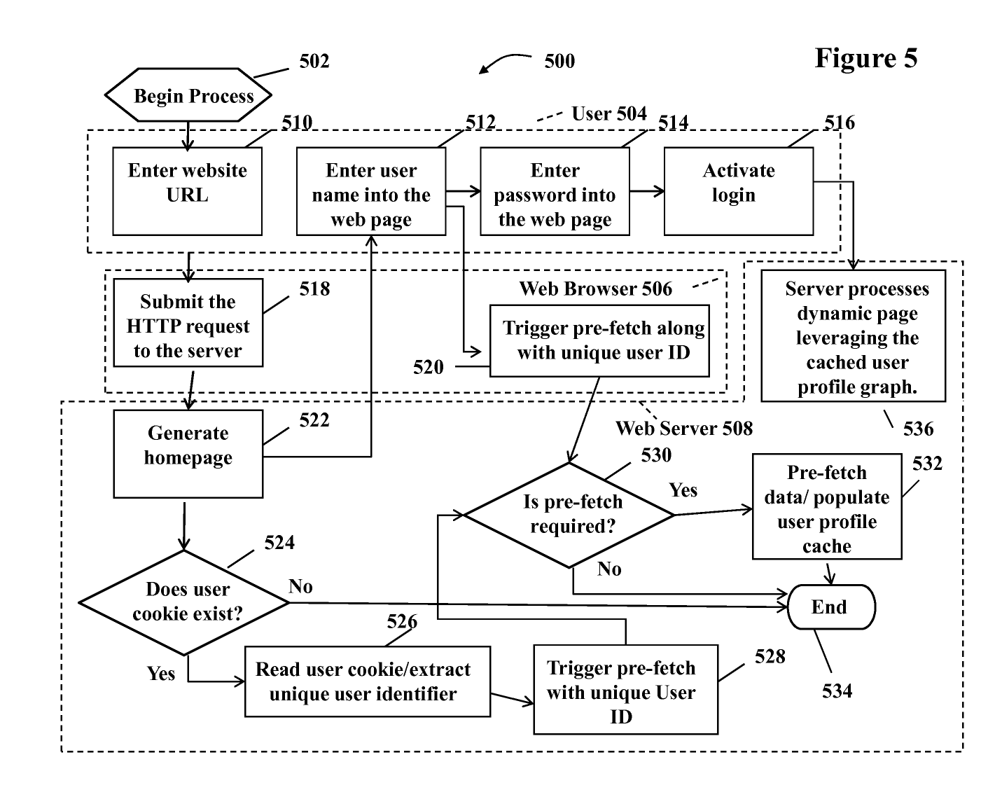

FIG. 5 illustrates a workflow diagram 500 of the present invention that begins at 502. The process 500 has three sections representing the activities performed by three participants: user 504; web browser 506; and web server 508 where the process steps are performed by the user, the web browser and the web server, respectively. At 510, user 504 enters the URL of the desired website into the web browser and, at 518, web browser 506 submits the HTTP request to the web server. At 522, web server 508 generates the selected home page and sends to user. When the home page is rendered to the user, the user types the user name into the web page at 512 and the web browser extracts the unique user identifier (ID).

Concurrently with the sending the homepage to the user, at 524, the web server 508 determines whether a user cookie exists and, if not, that part of the process ends at 534. If a user cookie exists, the web server 508 reads the cookie and extracts the unique user identifier at 526 and, at 528, the web server triggers a pre-fetch utilizing the unique user identifier. At 530, the web server determines whether a pre-fetch is necessary and, if not, the process ends at 534 as no new web page is necessary. If a pre-fetch is necessary at 530, at 532, the web server pre-fetches the data that has been customized for the user based upon the unique user identifier and populates the user profile cache (including the user profile graph) and that part of the process ends at 534. At the user 504, the user types the password into the web page at 514 while, concurrently, a pre-fetch is triggered at 520 by the web browser using the unique user identifier. Web browser passes the user unique identifier along with the pre-fetch trigger. At 516, the user clicks on (or otherwise activates) a Login hyperlink on the web page so that the user may be authenticated. Once the user is authenticated, at 536, the web server processes a dynamic web page (JSP, ASP, CGI, etc.) leveraging the cached user profile graph.

The work diagram 500 of FIG. 5 depicts a usage scenario of the present invention in relation to the pre-fetching of the cache during user interaction. Key activities within this workflow are “Trigger Pre-fetch” activities. Trigger pre-fetch steps initiate pre-fetching of data to be used once the user enters an authenticated state. This activity may be executed from the Web Browser 506 or the Web Server 508. Another key point to note is the asynchronous execution within this flow. There are two points that asynchronous executions (without interrupting the user) occur—after the “Generate homepage” 522 activity and after the “Enter username into the webpage” 512 activity. This allows the pre-fetching of data without interruption to the user.

Users of a web site can be classified according to two distinct types—authenticated and anonymous. Authenticated users have credentials such as a username and password for accessing restricted web pages within the web site. Anonymous users, on the contrary, do not have authentication credentials. Anonymous users may be “familiar” to a web-site based on prior web site access but do not have authentication credentials. Familiar users are typically tracked using a cookie or through registration of the user's Internet Protocol (IP) address. User roles indicated by a (+) may be supported by the present invention. In these cases, unique user information is leveraged by the application to pre-fetch the user profile graph in advance of the user authentication. Each of these user roles is a recognized user representing a user for which the application should have knowledge.

Authenticated (+)

Owner

Delegate

Viewer

Anonymous (Non-Authenticated)

Familiar (i.e., User Cookie exists) (+)

Unfamiliar (i.e., No User Cookie exists)

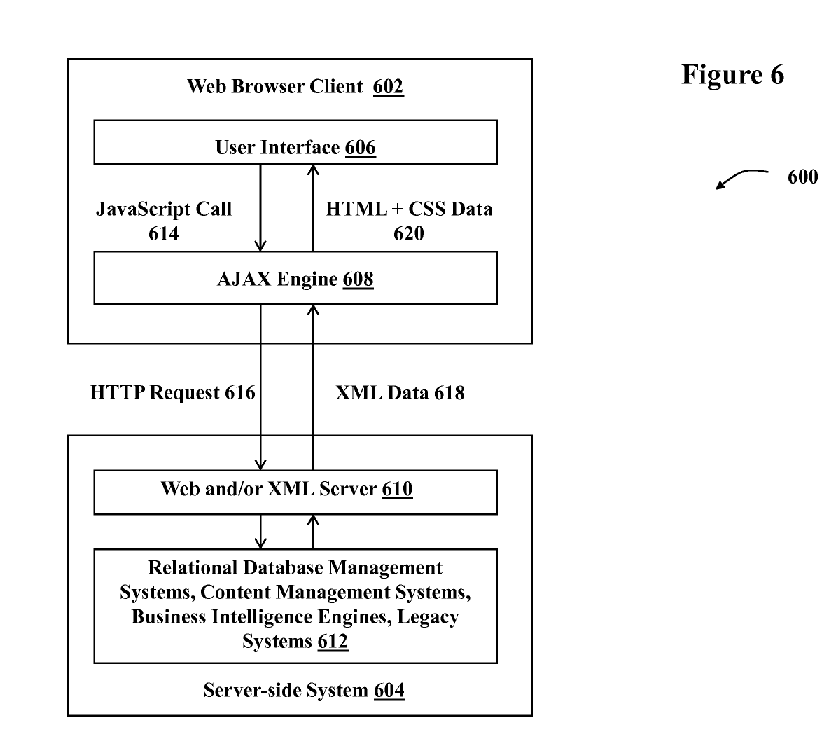

FIG. 6 illustrates the method and system 600 of the present invention employed using JavaScript® for performing asynchronous communication with the server. JavaScript is a trademark or registered trademark of Sun Microsystems, Inc. The system may have a web browser client 602 and a server-side system 604. Web browser client 602 and server-side system 604 exchange HTTP requests, such as HTTP request 616, and XML data, such as XML data 618. Web browser client 602 has a user interface 606 and an AJAX engine 608. User interface 602 provides an interface for the user to the network, such as the Internet, and provides JavaScript calls, such as JavaScript call 614, to AJAX engine 608. AJAX (asynchronous JavaScript and XML) is a group of interrelated web development techniques used on the client-side to create interactive web applications or rich Internet applications. With AJAX, web applications can retrieve data from the server asynchronously in the background without interfering with the display and behavior of the existing page. AJAX engine 608 processes JavaScript call 614 and forwards HTTP request 616 to server-side system 604.

Server-side system 604 has a web and/or XML server 610 that receives the HTTP request 616 and passes it to a legacy systems unit 612 having Relational database management systems, content management systems, business intelligence engines, legacy systems and possibly others which responds to web and/or XML server 610 that passes the response as XML data 618 to AJAX engine 608. AJAX engine 608 processes XML data 618 and process HTML+CSS data 620 to the user interface 606 for presenting to the user.

One advantage of using this technique is that no interruption to the user interaction occurs. The user can continue the authentication process including entering the userid (unique user identifier) while the server-side system is processing the request.

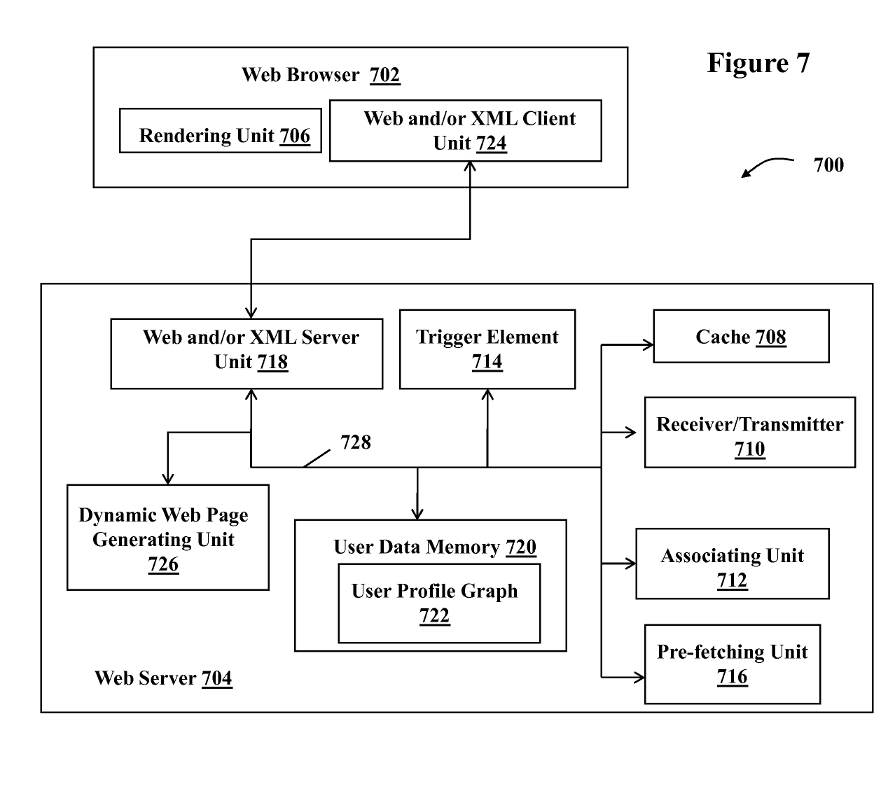

FIG. 7 illustrates a system 700 of the present invention having a web browser 702 and a web server 704, each having a web and/or XML client unit 724 and a web and/or XML server unit 718, respectively, to communicate with one another over the Internet. The web browser 702 further has a rendering unit 706 for rendering web pages sent from the web server 704 to the web browser 702 to the user of the web browser 702. Web server 704 further has a cache 708, a receiver/transmitter 710, an associating unit 712, a pre-fetching unit 716, a user data memory 720 having a user profile graph 722, a trigger element 714, and a dynamic web page generating unit 726. All may be interconnected by a web server bus 728.

The system 700 utilizes for pre-fetching, to the cache 708, customized web content for a user pre-fetching unit 716. The user pre-fetching unit 716 pre-fetches customized web content to the cache 708 for the user. When the user selects a web site using web browser 702 that is received by the receiver/transmitter 710 of web server 704, the web server 704 generates the web site and sends the web site to the user via receiver/transmitter 710 to be rendered by the rendering unit 706 of the web browser 702. The web server 704 determines whether the user has a user cookie. A cookie (also tracking cookie, browser cookie, and HTTP cookie) is a small piece of text stored on a user's computer by a web browser. A cookie consists of one or more name-value pairs containing bits of information such as user preferences, shopping cart contents, the identifier for a server-based session, or other data used by websites. From the user cookie, the web server 704 determines the unique user identifier and utilizes the trigger element 714 for determining whether a pre-fetch is required and triggering a pre-fetch of web content customized for the user based upon the unique user identifier using the pre-fetching element 716. Pre-fetching element 716 utilizes associating element 712 for associating the customized web content with the user and storing the customized web content in the user profile graph 722 of the user data memory 720.

Concurrently, the user is allowed to enter his username on the provided webpage, at time which the content is pre-fetch required process is initiated and, if so, the pre-fetch is run by the pre-fetching unit 716 based upon the unique user identifier, utilizes the associating unit 712 to associate web content with the user and stores the customized web content in the user profile graph 722 in user data memory 720. Once the user is authorized, dynamic web page generating unit 726 generates the customized web page and receiver transmitter 710 transmits the customized web page to the web browser 702.

While shown and described herein as a system and methods to allow for pre-fetching of customized web content associated with a user profile in a cache upon receiving user identification, but before the user provides authentication details, the present invention further provides a method and system for rendering of the cached customized web content to the user once the user authentication is received. While the present invention also provides for pre-fetching of customized web content associated with a user profile in a cache upon receiving user identification, but before the user provides authentication details, it is understood that the invention further provides various alternative embodiments. For example, in one embodiment, the invention provides a computer-readable/useable medium that includes computer program code to enable a computer infrastructure for a system for pre-fetching of customized web content associated with a user profile in a cache upon receiving user identification, but before the user provides authentication details. To this extent, the computer-readable/useable medium includes program code that implements each of the various process steps of the invention.

It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory and/or storage system (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a computer-implemented method for pre-fetching of customized web content associated with a user profile in a cache upon receiving user identification, but before the user provides authentication details. In this embodiment of the present invention, a computerized infrastructure may be provided and one or more systems may be provided for performing process steps of the invention that may be obtained and deployed to the computerized infrastructure.

The deployment of a system can comprise one or more of installing program code on a computing device, such as computer system from a computer-readable medium, adding one or more computing devices to the computer infrastructure, and incorporating and/or modifying one or more existing systems of the computer infrastructure to enable the computerized infrastructure to perform the method steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A method in a system having a web server having a cache and a web browser for a user, the method for pre-fetching, to the cache, customized web content for the user, the system having a user profile for the user, the user profile having a unique user identifier identifying the user, the method comprising:
receiving the unique user identifier from the user;
associating customized web content with the user profile based upon the user identifier of the user;
pre-fetching the associated customized web content to the cache based upon the unique user identifier and the user profile; and
receiving a user authentication authenticating the user to the web server.

2. The method as defined in claim 1 further comprising rendering the pre-fetched cached customized web content to the web browser of the user once the user authentication is received.

3. The method as defined in claim 1 further comprising populating the user profile with the pre-fetched associated customized web content.

4. The method as defined in claim 1 further comprising:
receiving a request from the user for dynamically generated user-tailored web content;
dynamically generating user-tailored web content based upon the user profile;
receiving the user authentication; and
rendering the dynamically generated user-tailored web content to the user after user authentication.

5. The method as defined in claim 2 further comprising determining whether a user cookie exists for the user, extracting the user identifier, triggering the web server to pre-fetch user-specific resources into a user profile graph when a user cookie is present.

6. The method as defined in claim 2 further comprising triggering the web server to pre-fetch user-specific resources into the user profile when the user navigates to the web site.

7. The method as defined in claim 2 further comprising triggering the web server to pre-fetch user-specific resources into the user profile when user authentication is received.

8. The method as defined in claim 2 in a system having a web browser further comprises:
receiving, at the web server, a hypertext transfer protocol (HTTP) request having a Universal Resource Locator (URL) identifying a web page from the web browser;
constructing by the web server the identified web page;
rendering the constructed identified web page to the user;
receiving at the web browser from the user a username;
determining, by the web server, whether a user cookie exists;
if a user cookie exists, reading the user cookie and extracting a unique user identifier by the web server;
pre-fetching customized user web content based upon the unique user identifier and populating a user profile cache including a user profile graph associated with the user;
receiving a password from the user; and
processing by the web server a dynamic web page using the customized user web content and the cached user profile graph.

9. The method as defined in claim 8 further comprising determining whether a pre-fetch is needed.

10. The method as defined in claim 8 further comprising passing to the web server the unique user identifier by the user and, if a pre-fetch is needed, pre-fetching the customized user web data and populating a user profile cache.

11. A system for pre-fetching, to a cache, customized web content for a user having a user profile, the user profile having a unique user identifier identifying the user, the system comprising:
a cache;
a receiver for receiving the unique user identifier from the user and for receiving in a web server a user authentication;
an associating unit for associating customized web content with the user profile based upon the unique user identifier; and
a pre-fetching unit for pre-fetching the associated customized web content to the cache.

12. The system as defined in claim 11 further comprising a rendering unit for rendering the pre-fetched cached customized web content to the user once the user authentication is received.

13. The system as defined in claim 12 further comprising a web browser for sending a request to the web server from the user for customized web content from the web server, wherein the web server dynamically generates customized web content based upon the user profile and performs the user authentication, and the web browser renders the dynamically generated customized web content after user authentication.

14. The system as defined in claim 13 further comprising a user profile graph in the user profile, a trigger element for triggering the pre-fetching unit to pre-fetch user-specific resources into user profile graph when a user cookie is present.

15. The system as defined in claim 13 further comprising a trigger element for triggering the pre-fetching unit to pre-fetch user-specific resources into a user profile graph when the user navigates to the web site.

16. The system as defined in claim 15 further comprising a dynamic page generating unit for dynamically generating a page based upon the user profile graph.

17. A computer program product embodied in a computer readable medium for operating in a system comprising a processing unit, a memory, a bus, input/output (I/O) interfaces, a web server having a cache, and a web browser for a user, for implementing a method for pre-fetching, to the cache, customized web content for the user having a user profile, the user profile having a unique user identifier identifying the user, the method comprising:
receiving in the web server the unique user identifier from the user;
associating customized web content with the user profile based upon the user identifier of the user;
pre-fetching the associated customized web content to the cache based upon the unique user identifier and the user profile; and then
receiving in the web server user a user authentication authenticating the user to the web server.

18. The computer program product as defined in claim 17 wherein the method further comprises rendering the pre-fetched cached customized web content to the web browser of the user once the user authentication is received.

19. The computer program product as defined in claim 18 wherein the method further comprises populating the user profile with the pre-fetched associated customized web content.

20. The computer program product as defined in claim 17 wherein the method further comprises:
receiving a request from the user for dynamically generated user-tailored web content;
dynamically generating user-tailored web content based upon the user profile;
receiving the user authentication; and
rendering the dynamically generated user-tailored web content to the user after user authentication.

21. A method for deploying computing infrastructure comprising integrating computer-readable code into a computing system, the computing system having a web server having a cache, and a web browser for a user, wherein the code in combination with the computing system is capable of performing a process for pre-fetching, to the cache, customized web content for the user having a user profile, the user profile having a unique user identifier identifying the user, the process comprising:
receiving, at the web server, a hypertext transfer protocol (HTTP) request having a Universal Resource Locator (URL) identifying a web page from the web browser;
constructing by the web server the identified web page;
rendering the constructed identified web page to the user;
receiving at the web browser from the user a username;
determining, by the web server, whether a user cookie exists;
if a user cookie exists, reading the user cookie and extracting a unique user identifier by the web server;
pre-fetching customized user web content based upon the unique user identifier and populating a user profile cache including a user profile graph associated with the user;
receiving a password from the user; and
processing by the web server a dynamic web page using the customized user web content and the cached user profile graph.
